(19) United States
(12) Patent Application Publication
(10) Pub. No.: US 2025/0315367 A1
(43) Pub. Date: Oct. 9, 2025

(54) System and Method for Improving the Testing Phase of Software Development Life Cycles

(71) Applicant: Bank of America Corporation, Charlotte, NC (US)

(72) Inventors: Maneesh Kumar Sethia, Hyderabad (IN); Sivashalini Sivajothi, Chennai (IN); Shailendra Singh, Thane West (IN)

(21) Appl. No.: 18/630,434

(22) Filed: Apr. 9, 2024

(51) Int. Cl. G06F 11/36

(52) U.S. Cl. CPC G06F 11/3688; G06F 11/3684

(57) ABSTRACT

A method includes accessing a selected population of test cases, a first set of fitness criteria, and a second set of fitness criteria. The selected population of test cases is configured to test a functionality of a first or second instance of a software application. The method includes determining, based on the selected population of test cases and the first set of fitness criteria, a fitness score for each test case, and iteratively executing a natural computing algorithm to identify best possible test cases based on the fitness score for each test case. In response to determining that the identified best possible test cases satisfies the second set of fitness criteria, the method includes generating an output comprising the identified best possible test cases, and executing, based on the output, the identified best possible test cases to test the functionality of the first or second instance of the software application.

### TECHNICAL FIELD

The present disclosure relates generally to computing systems, and, more specifically, to a system and method for improving the testing phase of software development life cycles.

### BACKGROUND

A software development life cycle (SDLC) generally includes a phase-by-phase process or project management and development framework utilized by software development teams to design and build useful software applications and systems. For example, a typical SDLC may include a planning phase, a design phase, a development phase, a testing phase, a deployment phase, and a maintenance phase. Often, the testing phase of the SDLC is important because it relates to the intended purpose and use of the software. However, identifying and prioritizing which of the various functionalities of a given software application to test may be cumbersome, time-consuming, and susceptible to error.

### SUMMARY

The system and methods implemented by the system as disclosed in the present disclosure provide technical solutions to the technical problems discussed above by providing systems and methods for improving the testing phase of software development life cycles (SDLCs). The disclosed system and methods provide several practical applications and technical advantages. Specifically, the present embodiments improve the security, reliability, and maintainability of software applications, systems, and networks, as well as the one or more processors and memory on which the software applications, systems and networks may be executed by autonomously identifying, prioritizing, and optimizing test cases based on a particular requirement of a software application to be tested and generating a prioritized and optimized output of test cases utilizing a genetic algorithm (GA).

Thus, the present embodiments may improve software bug tracking and detection accuracy and software bug tracking and detection efficiency during the testing phase of the SDLC, and thereby mitigate the potential for any downstream software application bugs, software application faults, software application outages, or other systemic vulnerabilities that may be associated with software applications, systems, and networks once deployed. The present embodiments may further efficiently allocate the processing workloads of the one or more processors and the storage capacity of the memory by autonomously identifying, prioritizing, optimizing, and executing only those test cases of a given test suite determined to be the best and most “fit” for accurately testing and validating the functionalities and/or requirements of a given software application.

Indeed, in accordance with the presently disclosed embodiments, one or more processors of a software test case management system may iteratively execute a genetic algorithm (GA) to identify and prioritized test cases for testing the functionality of one or more newly introduced features of a software application during the testing phase of the software development life cycle (SDLC). Specifically, test case prioritization may include the process of assigning priority levels to individual test cases based on their significance, criticality, and potential impact on the software application being tested. In particular embodiments, the one or more processors may first access a selected population of test cases of a total population of test cases generated by an input engine of the test case management system. The one or more processors may then determine a fitness score for each test case of the selected population of test cases based on a first fitness criteria, which includes, for example, a requirement coverage and a functionality of the software application to be tested. The one or more processors may then input the highest scored test cases to a genetic algorithm (GA), which may be utilized to identify the best prioritized and optimized test cases for testing the functionality of the software application. The one or more processors may then validate and execute the identified best prioritized and optimized test cases to test the functionality of the software application.

In this way, the present embodiments may improve the security, reliability, and maintainability of software applications, systems, and networks, as well as the one or more processors and memory on which the software applications, systems and networks may be executed by autonomously identifying, prioritizing, and optimizing test cases based on a particular functionality or requirement of a software application to be tested and generating a prioritized and optimized output of test cases utilizing a genetic algorithm (GA). Specifically, the present embodiments may improve software bug tracking and detection accuracy and software bug tracking and detection efficiency during the testing phase of the SDLC, and thereby mitigate the potential for any downstream software application bugs, software application faults, software application outages, or other systemic vulnerabilities that may be associated with software applications, systems, and networks once deployed. The present embodiments may further efficiently allocate the processing workloads of the one or more processors and the storage capacity of the memory by autonomously identifying, prioritizing, optimizing, and executing only those test cases of a given test suite determined to be the best and most “fit” for accurately testing and validating the functionalities and/or requirements of a given software application.

The present embodiments are directed to systems and methods for improving the testing phase of software development life cycles (SLDCs). In particular embodiments, one or more processors of a test case management system may access a selected population of test cases, a first set of fitness criteria, and a second set of fitness criteria. In particular embodiments, the selected population of test cases may be configured to test a functionality of one or more of a first instance of a software application or a second instance of the software application. In one embodiment, the selected population of test cases may include a subset of a total population of test cases. For example, in one embodiment, prior to accessing the selected population of test cases and the first set of fitness criteria, the one or more processors may generate the selected population of test cases based on the total population of test cases.

In particular embodiments, the first instance of the software application may include an instance of the software application during development time, and the second instance of the software application may include an instance of the software application during runtime. In particular embodiments, the one or more processors may then access the selected population of test cases and the first set of fitness criteria. For example, in particular embodiments, prior to determining the fitness score for each test case of the selected population of test cases, the one or more processors may initialize the selected population of test cases and assign each test case of the selected population of test cases to one of a plurality of test suites based at least in part on a functionality to be tested.

In particular embodiments, the one or more processors may then determine, based on the selected population of test cases and the first set of fitness criteria, a fitness score for each test case of the selected population of test cases. In particular embodiments, the one or more processors may then iteratively execute a natural computing algorithm to identify one or more best possible test cases based at least in part on the fitness score for each test case of the selected population of test cases. For example, in one embodiment, the natural computing algorithm may include a genetic algorithm (GA).

In particular embodiments, the one or more processors may execute the genetic algorithm (GA) by selecting a set of test cases from the selected population of test cases. For example, the selected set of test cases may include test cases having a highest fitness score. In particular embodiments, the one or more processors may further execute the genetic algorithm (GA) by generating, based at least in part on the selected set of test cases, at least one new test case by 1) identifying a crossover point between at least one pair of test cases of the selected set of test cases and 2) alternating one or more values of a sequence of values representative of each test case of the at least one pair of test cases. For example, in one embodiment, the one or more values of the sequence of values may be alternated until the identified crossover point between the at least one pair of test cases is reached. In particular embodiments, the one or more processors may further execute the genetic algorithm (GA) by performing a mutation of the at least one new test case by altering one or more values of a sequence of values representative of the at least one new test case, and then generating a new population of test cases, wherein the new population of test cases comprises the at least one new test case.

In particular embodiments, in response to determining that the identified one or more best possible test cases satisfies the second set of fitness criteria, the one or more processors may then generate an output including the identified one or more best possible test cases. For example, in particular embodiments, the one or more processors may determine whether the identified one or more best possible test cases satisfies the second set of fitness criteria based at least in part on whether the identified one or more best possible test cases satisfies one or more of a credibility criterion, a feasibility criterion, a requirement coverage criterion, or a traceability criterion. In particular embodiments, the one or more processors may then execute, based at least in part on the output, the identified one or more best possible test cases to test the functionality of the one or more of the first instance of the software application or the second instance of the software application.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a test case management system for improving the testing phase of software development life cycles (SDLCs), in accordance with certain aspects of the present disclosure;

FIG. 2 illustrates a block diagram of an embodiment of a software test management and natural computing algorithm system for improving the testing phase of software development life cycles (SDLCs), in accordance with one or more embodiments of the present disclosure; and

FIG. 3 illustrates a flowchart of an example method for improving the testing phase of software development life cycles (SDLCs), in accordance with one or more embodiments of the present disclosure.

### DETAILED DESCRIPTION

### Example System

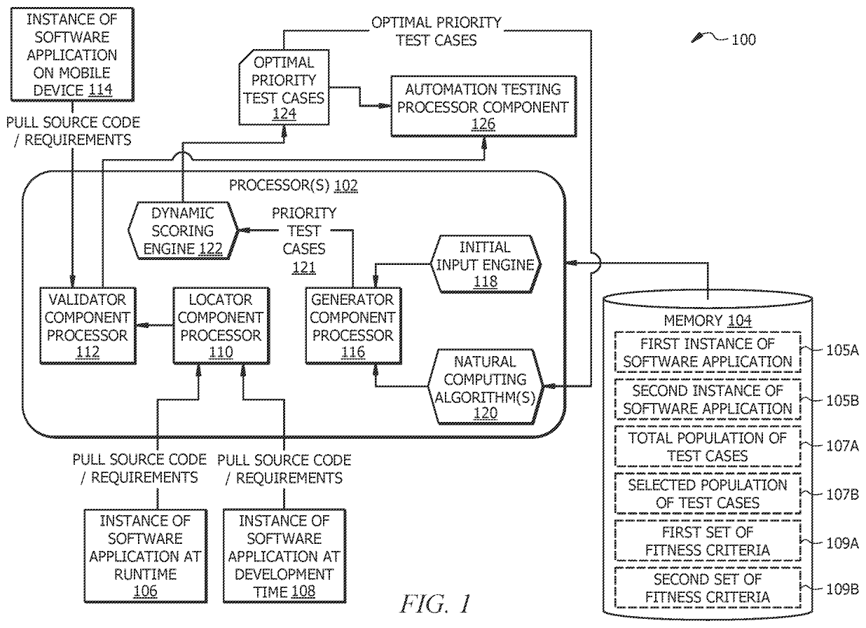

FIG. 1 is a schematic diagram of a test case management system 100 for improving the testing phase of software development life cycles (SDLCs), in accordance with certain aspects of the present disclosure. As depicted, the test case management system 100 may include one or more processors 102 and a memory 104, which may be utilized in conjunction to improve the testing phase of software development life cycles (SDLCs) in accordance with the presently disclosed embodiments. The one or more processors 102 may be operably coupled to the memory 104.

For example, the one or more processors 102 may include any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). In some embodiments, the one or more processors 102 may be a programmable logic device, a microcontroller, a microprocessor, or any suitable combination of the preceding.

The one or more processors 102 may be further communicatively coupled to and in signal communication with the memory 104. The one or more processors may be configured to process data and may be implemented in hardware or software. For example, the one or more processors 102 may be 8-bit, 16-bit, 32-bit, 64-bit or of any other suitable architecture. The one or more processors 102 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors 102 may be further configured to implement various instructions. For example, the one or more processors 102 may be configured to execute instructions stored by the memory 104. In such instances, the one or more processors 102 may be a special-purpose computer designed to implement and execute the functions disclosed herein.

The memory 104 may include one or more disks, tape drives, or solid-state drives, and may be used as an over-flow data storage device, to store programs when such programs are selected for execution, and to store instructions and data that are read during program execution. The memory 104 may be volatile or non-volatile and may include a read-only memory (ROM), random-access memory (RAM), ternary content-addressable memory (TCAM), dynamic random-access memory (DRAM), static random-access memory (SRAM), and so forth. In one embodiment, the memory 104 may include a non-transitory computer-readable medium. As further depicted by the test case management system 100 of FIG. 1, in particular embodiments, the memory 104 may be operable to store a first instance of the software application 105A and a second instance of the software application 105B. For example, in particular embodiments, the first instance of the software application 105A may include an executing instance of an existing runtime software application 106 and the second instance of the software application 105B may include an in-development instance of a development time software application 108.

The memory 104 may be further operable to store a total population of test cases 107A, a selected population of test cases 107B, a first set of fitness criteria 109A, and a second set of fitness criteria 109B. For example, in one embodiment, the selected population of test cases 107B may be utilized to test a functionality or one or more requirements of one or more of the first instance of a software application 105A, a second instance of a software application 105B, or the mobile device instance of a software application 114. In particular embodiments, the selected population of test cases 107B may include a subset of the total population of test cases 107A. For example, in one embodiment, the initial input engine 118 may generate the selected population of test cases 107B utilizing the total population of test cases 107A.

As further depicted by the test case management system 100 of FIG. 1, the one or more processors 102 may include a locator component processor 110, a validator component processor 112, and a generator component processor 116. Although these processors 110, 112, and 116 are illustrated as separate components, they may be implemented in any suitable number and combination of processors to suitable particular tasks of the test case management system 100. The locator component processor 110 may access the runtime software application 106 and access the development time software application 108 and pull a source code and/or one or more requirements that may be associated with testing the runtime software application 106 and the development time software application 108. The locator component processor 110 may then provide the source code and/or the requirements to the validator component processor 112.

As further depicted by the test case management system 100 of FIG. 1, the validator component processor 112 may access a mobile device instance of a software application 114. For example, in one embodiment, the mobile device instance of a software application 114 may include a mobile application instance of the software application suitable for executing on a mobile electronic device, and thus the validator component processor 112 may be utilized to pull source code and/or one or more requirements that may be associated with testing the mobile device instance of a software application 114. In particular embodiments, as will be further appreciated below, the validator component processor 112 may provide the source code and/or one or more requirements pulled from the first instance of a software application 105A, the second instance of a software application 105B, or the mobile device instance of a software application 114 to the automation testing processor component 126 to execute prioritized and optimized test cases 124 with respect thereto.

In particular embodiments, as further depicted by FIG. 1, the one or more processors 102 may execute one or more natural computing algorithm(s) 120 that may be utilized to generate a population of best possible test cases 121. For example, in one embodiment, in response to determining a fitness score based on the first set of fitness criteria 109A for each test case of the selected population of test cases 107B, the one or more processors 102 may iteratively execute the one or more natural computing algorithm(s) 120 to identify and generate the population of best possible test cases 121. For example, in one embodiment, the one or more natural computing algorithm(s) 120 may include a genetic algorithm (GA) or other similar natural computing algorithm (e.g., an evolutionary algorithm (EA), a bio-inspired algorithm (BIA), a swarm intelligence-based algorithms (SIA), a particle swarm optimization (PSO) algorithm, and so forth) that may be suitable for identifying and generating the prioritized and optimized test cases 124 for testing the functionality or one or more requirements of one or more of the first instance of a software application 105A, the second instance of a software application 105B, or the mobile device instance of a software application 114.

In particular embodiments, upon identifying and generating the population of best possible test cases 121, the one or more natural computing algorithm(s) 120 may then provide the population of best possible test cases 121 to the dynamic scoring engine 122. In particular embodiments, the dynamic scoring engine 122 may then determine whether the dynamic scoring engine 122 satisfies the second set of fitness criteria 109B. In one embodiment, the second set of fitness criteria 109B may include, for example, a credibility criterion, a feasibility criterion, a requirements coverage criterion, and a requirements traceability criterion by which the population of best possible test cases 121 may be validated.

In particular embodiments, in response to determining that the population of best possible test cases 121 satisfies the second set of fitness criteria 109B, the dynamic scoring engine 122 method 300 may then score or rank each test case of the population of best possible test cases 121 and generate and output the prioritized and optimized test cases 124. The dynamic scoring engine 230 may then provide the prioritized and optimized test cases 124 to the automation testing processor component 126. For example, the automation testing processor component 126 may execute the prioritized and optimized test cases 124 to test the functionality or one or more requirements of one or more of the first instance of a software application 105A, the second instance of a software application 105B, or the mobile device instance of a software application 114.

### Improving the Testing Phase of Software Development Life Cycles

Embodiments of the present disclosure discuss techniques for improving the testing phase of software development life cycles (SLDCs).

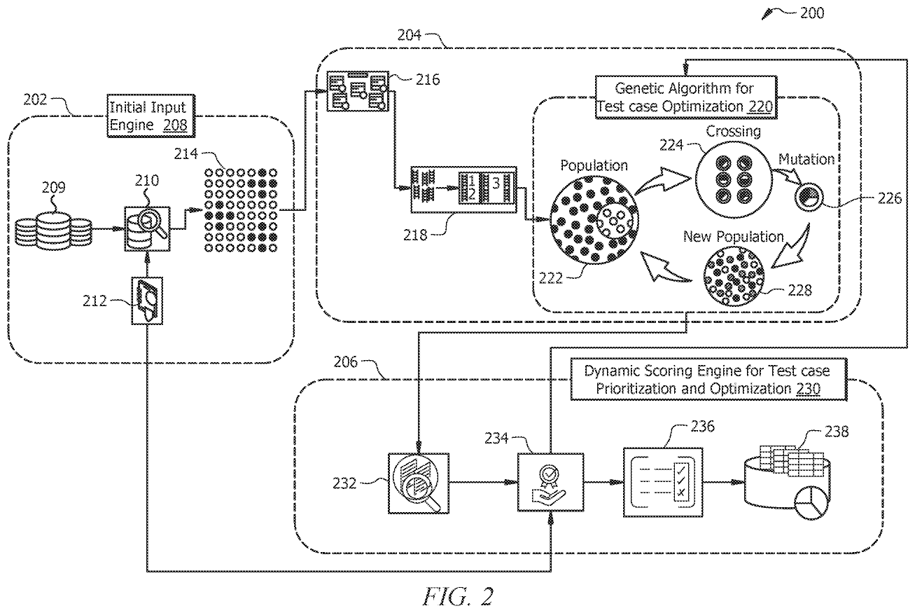

FIG. 2 illustrates a block diagram of an embodiment of a software test case management and natural computing algorithm and system 200 for improving the testing phase of software development life cycles (SLDCs), in accordance with certain aspects of the present disclosure. As depicted, the software test case management and natural computing algorithm and system 200 may include an initial input engine and system 202, a genetic algorithm (GA) and system 204, and a dynamic scoring engine and system 206. In particular embodiments, the initial input engine and system 202 may include an initial input engine 208, a database 209 of a total population of test cases, a dynamic test case generator 210, a software application requirements feeder 212, and a selected population of test cases 214.

In particular embodiments, the initial input engine 208 may be any compute engine suitable for generating the selected population of test cases 214 utilizing the total population of test cases stored to the database 209 and the software application requirements identified by the software application requirements feeder 212. For example, in one embodiment, the software application requirements feeder 212 may access code or software requirements corresponding, for example, to the runtime software application 106, the development time software application 108, or the mobile device instance of a software application 114. In particular embodiments, the software application requirements feeder 212 may include one or more natural-language processing (NLP) models suitable for identifying keywords corresponding to one or more functionalities or requirements to be tested as included within the total population of test cases prewritten by developers and stored to the database 209.

In particular embodiments, the dynamic test case generator 210 may then utilize the keywords corresponding to the requirements to be tested as identified by the software application requirements feeder 212 to extract the selected population of test cases 214. In particular embodiments, the initial input engine 208 may then provide the selected population of test cases 214 to the genetic algorithm (GA) and system 204. As depicted, the genetic algorithm (GA) and system 204 may include a test suite initializer 216, a fitness function analyzer 218, and a genetic algorithm (GA) process 220. In particular embodiments, the test suite initializer 216 may include any software analyzer that may be suitable for initializing the selected population of test cases 214, and further assigning each test case of the selected population of test cases 214 to one of a number of test suites based on the one or more functionalities or requirements to be tested. For example, in one embodiment, each test suite may include a subset of the selected population of test cases 214 grouped and categorized based the one or more functionalities or requirements to be tested.

In particular embodiments, the test suite initializer 216 may then provide the initialized and assigned selected population of test cases 214 to the fitness function analyzer 218. The fitness function analyzer 218 may include any software analyzer that may be utilized to determine a fitness score for each test case of the initialized and assigned selected population of test cases 214. For example, in one embodiment, the fitness function analyzer 218 may determine a fitness score for each test case of the initialized and assigned selected population of test cases 214 based on the first set of fitness criteria 109A. In one embodiment, the first set of fitness criteria 109A may include, for example, a requirement coverage and a functionality to be tested. The fitness function analyzer 218 may then identify a population of highest scored test cases 222 of the initialized and assigned selected population of test cases 214, and further provide the population of highest scored test cases 222 as an input to the genetic algorithm (GA) process 220.

In particular embodiments, the genetic algorithm (GA) process 220 may be then iteratively executed to generate a population of new test cases 228. For example, as part of the crossover subprocess 224, the genetic algorithm (GA) process 220 may first identify a crossover point between pairs of test cases (e.g., one or more pairs of “parent” test cases) of the population of highest scored test cases 222. The genetic algorithm (GA) process 220 may then alternate one or more values of a sequence of values (e.g., “genes” represented as binary values “0” or “1”) representative of each test case of the pairs of test cases. For example, in one embodiment, the genetic algorithm (GA) process 220 may alternate the one or more values (e.g., alternate “0's” and “1's”) until the identified crossover point(s) is reached. In particular embodiments, once having alternated the one or more values of the sequences of values representative of each test case of the pairs of test cases (e.g., one or more pairs of “parent” test cases) up until the crossover point in accordance with the crossover subprocess 224, the resultant sequences of values (e.g., “genes” represented as binary values “0” or “1”) may represent the population of new test cases 228 (e.g., one or more “offspring” test cases).

In particular embodiments, as part of the mutation subprocess 226, the genetic algorithm (GA) process 220 may then alter one or more additional values of the resultant sequences of values (e.g., “genes” represented as binary values “0” or “1”) representing the population of new test cases 228 (e.g., one or more “offspring” test cases). For example, in one embodiment, the mutation subprocess 226 may include altering the resultant sequences of values by, for example, flipping “0's” into “1's” and “1's” into “0's,” and thereby generating the final population of new test cases 228. As previously noted, the genetic algorithm (GA) process 220 may be executed iteratively until only a final population of new test cases 228 determined to be the best and most “fit” for accurately testing and validating the functionalities and/or requirements of a given software application is identified.

In particular embodiments, upon the genetic algorithm (GA) process 220 generating the final population of new test cases 228, the genetic algorithm (GA) process 220 may then provide the final population of new test cases 228 to the dynamic scoring engine and system 206. As depicted, the dynamic scoring engine and system 206 may include a dynamic scoring engine 230, a duplicate checker system 232, an optimal solution checker 234, a dynamic test case scorer 236, and a final set of optimized and prioritized test cases 238 to be executed. For example, in particular embodiments, the dynamic scoring engine 230 may include any compute engine that may be suitable for determining whether the final population of new test cases 228 satisfies the second set of fitness criteria 109B. In one embodiment, the second set of fitness criteria 109B may include, for example, one or more of a credibility criterion, a feasibility criterion, a requirements coverage criterion, or a requirements traceability criterion.

In particular embodiments, the duplicate checker system 232 may be any software checker that may be utilized to remove any duplicate test cases identified within the final population of new test cases 228. In particular embodiments, the optimal solution checker 234 may be utilized to validate the final population of new test cases 228 by determining whether the final population of new test cases 228 satisfies the second set of fitness criteria 109B. For example, the optimal solution checker 234 may receive an input of the final population of new test cases 228 as generated by the dynamic scoring engine 230, as well as an input of the identified keywords corresponding to one or more functionalities or requirements to be tested as identified by the software application requirements feeder 212. Thus, the optimal solution checker 234 may validate the final population of new test cases 228 by evaluating whether the final population of new test cases 228 satisfies one or more of a predetermined credibility criterion, feasibility criterion, requirements coverage criterion, or requirements traceability criterion.

In one embodiment, upon the optimal solution checker 234 determining that the final population of new test cases 228 fails to satisfy the criteria, the optimal solution checker 234 may provide a feedback response to the genetic algorithm (GA) process 220 to continue iteratively executing to generate a better and more “fit” population of new test cases 228. In another embodiment, upon the optimal solution checker 234 determining that the final population of new test cases 228 satisfies the criteria, the optimal solution checker 234 may then provide the final population of new test cases 228 to the dynamic test case scorer 236. In particular embodiments, the dynamic test case scorer 236 may then perform a prioritization and optimization scoring or ranking of the final population of new test cases 228 and generate a final set of optimized and prioritized test cases 238 to be executed, for example, by the automation testing processor component 126 as discussed above with respect to FIG. 1.

Thus, in accordance with the presently disclosed embodiments, the test case management and natural computing algorithm and system 200 may improve the security, reliability, and maintainability of software applications, systems, and networks, as well as the one or more processors 102 and memory 104 on which the software applications, systems and networks may be executed by autonomously identifying, prioritizing, and optimizing test cases based on a particular functionality or requirement of a software application to be tested and generating a prioritized and optimized output of test cases utilizing a genetic algorithm (GA) process 220.

Indeed, the present embodiments may improve software bug tracking and detection accuracy and software bug tracking and detection efficiency during the testing phase of the SDLC, and thereby mitigate the potential for any downstream software application bugs, software application faults, software application outages, or other systemic vulnerabilities that may be associated with software applications, systems, and networks once deployed. The present embodiments may further efficiently allocate the processing workloads of the one or more processors 102 and the storage capacity of the memory 104 by autonomously identifying, prioritizing, optimizing, and executing only those test cases of a given test suite determined to be the best and most “fit” for accurately testing and validating the functionalities and/or requirements of a given software application.

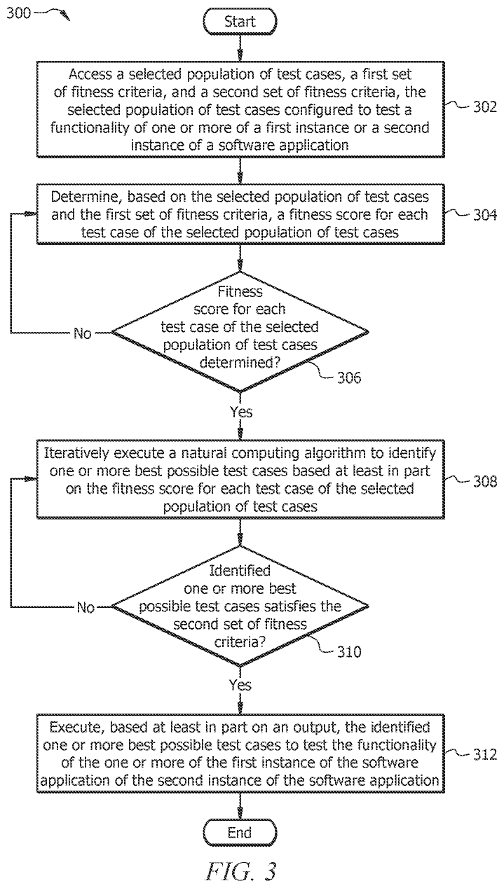

FIG. 3 illustrates a flowchart of an example method 300 for improving the testing phase of software development life cycles (SDLCs), in accordance with one or more embodiments of the present disclosure. The method 300 may be performed utilizing the one or more processors 102 (e.g., locator component processor 110, validator component processor 112, and generator component processor 116) as described above with respect to FIG. 1.

The method 300 may begin at block 302 with the one or more processors 102 accessing a selected population of test cases, a first set of fitness criteria, and a second set of fitness criteria. For example, in one embodiment, the selected population of test cases 107B may be utilized to test a functionality or one or more requirements of one or more of the first instance of a software application 105A, a second instance of a software application 105B, or the mobile device instance of a software application 114. In particular embodiments, the selected population of test cases 107B may include a subset of the total population of test cases 107A. For example, as previously noted above with respect to FIG. 2, the initial input engine 208 may generate the selected population of test cases 107B utilizing the total population of test cases 107A.

The method 300 may then continue at block 304 with the one or more processors 102 determining, based on the selected population of test cases and the first set of fitness criteria, a fitness score for each test case of the selected population of test cases. For example, as discussed above with respect to FIG. 2, the initial input engine 208 may provide the selected population of test cases 107B to the test suite initializer 216. In particular embodiments, the test suite initializer 216 may then initialize the selected population of test cases 107B and assign each test case of the selected population of test cases 107B to one of a number of different test suites based on one or more functionalities to be tested. In particular embodiments, the test suite initializer 216 may then provide the initialized and assigned test cases of the selected population of test cases 107B to the fitness function analyzer 218. As discussed above with respect to FIG. 2, the fitness function analyzer 218 may then determine, based on the initialized and assigned test cases of the selected population of test cases 107B and the first set of fitness criteria 109A (e.g., requirement coverage and functionality to be tested), a fitness score for each test case of the initialized and assigned test cases of the selected population of test cases 107B.

The method 300 may then continue at decision 306 with the one or more processors 102 confirming whether a fitness score for each test case of the selected population of test cases has been determined. For example, in response to determining that a fitness score for each test case of the initialized and assigned test cases of the selected population of test cases 107B has not been determined, the method 300 may continue with the one or more processors 102 returning to block 302 as discussed above. On the other hand, in response to determining that a fitness score for each test case of the initialized and assigned test cases of the selected population of test cases 107B has been determined, the method 300 may continue at block 308 with the one or more processors 102 iteratively executing a natural computing algorithm to identify one or more best possible test cases based at least in part on the fitness score for each test case of the selected population of test cases.

For example, in one embodiment, the natural computing algorithm may include a genetic algorithm (GA) process 220 or other similar natural computing algorithm (e.g., an evolutionary algorithm (EA), a bio-inspired algorithm (BIA), a swarm intelligence-based algorithms (SIA), a particle swarm optimization (PSO) algorithm, and so forth) that may be suitable for identifying and generating one or more best possible test cases for testing the functionality or one or more requirements of one or more of the first instance of a software application 105A, the second instance of a software application 105B, or the mobile device instance of a software application 114. The method 300 may then continue at decision 310 with the one or more processors 102 determining whether the identified one or more best possible test cases satisfies the second set of fitness criteria.

For example, in particular embodiments, upon identifying and generating the one or more best possible test cases, the genetic algorithm (GA) process 220 may then provide the identified one or more best possible test cases to the dynamic scoring engine 230. In particular embodiments, the dynamic scoring engine 230 may then determining whether the identified one or more best possible test cases satisfies the second set of fitness criteria 109B. In one embodiment, the second set of fitness criteria 109B may include, for example, a credibility criterion, a feasibility criterion, a requirements coverage criterion, and a requirements traceability criterion by which the identified one or more best possible test cases may be validated.

In particular embodiments, in response to determining that the identified one or more best possible test cases fails to satisfy the second set of fitness criteria 109B (e.g., at decision 310), the method 300 may continue with the one or more processors 102 returning to block 308 as discussed above. On the other hand, in response to determining that the identified one or more best possible test cases satisfies the second set of fitness criteria 109B (e.g., at decision 310), the method 300 may conclude at block 312 with the one or more processors 102 generating an output of the identified one or more best possible test cases and executing the identified one or more best possible test cases based on the output. For example, in particular embodiments, the dynamic scoring engine 230 may output the identified one or more best possible test cases (e.g., prioritized and optimized test cases 124), which may then be executed by the automation testing processor component 126 to test the functionality or one or more requirements of one or more of the first instance of a software application 105A, the second instance of a software application 105B, or the mobile device instance of a software application 114.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a total population of test cases, a selected population of test cases, a first set of fitness criteria, and a second set of fitness criteria, wherein the selected population of test cases is configured to test a functionality of one or more of a first instance of a software application or a second instance of the software application, and wherein the selected population of test cases comprises a subset of the total population of test cases; and
one or more processors operably coupled to the memory and configured to:
access the selected population of test cases and the first set of fitness criteria;
determine, based on the selected population of test cases and the first set of fitness criteria, a fitness score for each test case of the selected population of test cases;
iteratively execute a natural computing algorithm to identify one or more best possible test cases based at least in part on the fitness score for each test case of the selected population of test cases;
in response to determining that the identified one or more best possible test cases satisfies the second set of fitness criteria, generate an output comprising the identified one or more best possible test cases; and
execute, based at least in part on the output, the identified one or more best possible test cases to test the functionality of the one or more of the first instance of the software application or the second instance of the software application.

2. The system of claim 1, wherein the first instance of the software application comprises an instance of the software application during development time, and wherein the second instance of the software application comprises an instance of the software application during runtime.

3. The system of claim 1, wherein the one or more processors are further configured to:
prior to determining the fitness score for each test case of the selected population of test cases:
initialize the selected population of test cases; and
assign each test case of the selected population of test cases to one of a plurality of test suites based at least in part on a functionality to be tested.

4. The system of claim 1, wherein the natural computing algorithm comprises a genetic algorithm (GA).

5. The system of claim 4, wherein the one or more processors are further configured to execute the genetic algorithm (GA) by:
selecting a set of test cases from the selected population of test cases, wherein the selected set of test cases comprises test cases having a highest fitness score;
generating, based at least in part on the selected set of test cases, at least one new test case by 1) identifying a crossover point between at least one pair of test cases of the selected set of test cases and 2) alternating one or more values of a sequence of values representative of each test case of the at least one pair of test cases, the one or more values of the sequence of values being alternated until the identified crossover point between the at least one pair of test cases is reached;
performing a mutation of the at least one new test case by altering one or more values of a sequence of values representative of the at least one new test case; and
generating a new population of test cases, wherein the new population of test cases comprises the at least one new test case.

6. The system of claim 1, wherein the one or more processors are further configured to determine whether the identified one or more best possible test cases satisfies the second set of fitness criteria based at least in part on whether the identified one or more best possible test cases satisfies one or more of a credibility criterion, a feasibility criterion, a requirements coverage criterion, or a requirements traceability criterion.

7. The system of claim 1, wherein the one or more processors are further configured to:
prior to accessing the selected population of test cases and the first set of fitness criteria, generate the selected population of test cases based on the total population of test cases.

8. A method, comprising:
accessing a selected population of test cases, a first set of fitness criteria, and a second set of fitness criteria, wherein the selected population of test cases is configured to test a functionality of one or more of a first instance of a software application or a second instance of the software application, and wherein the selected population of test cases comprises a subset of a total population of test cases;
determining, based on the selected population of test cases and the first set of fitness criteria, a fitness score for each test case of the selected population of test cases;
iteratively executing a natural computing algorithm to identify one or more best possible test cases based at least in part on the fitness score for each test case of the selected population of test cases;
in response to determining that the identified one or more best possible test cases satisfies the second set of fitness criteria, generating an output comprising the identified one or more best possible test cases; and
executing, based at least in part on the output, the identified one or more best possible test cases to test the functionality of the one or more of the first instance of the software application or the second instance of the software application.

9. The method of claim 8, wherein the first instance of the software application comprises an instance of the software application during development time, and wherein the second instance of the software application comprises an instance of the software application during runtime.

10. The method of claim 8, further comprising:
prior to determining the fitness score for each test case of the selected population of test cases:
initializing the selected population of test cases; and
assigning each test case of the selected population of test cases to one of a plurality of test suites based at least in part on a functionality to be tested.

11. The method of claim 8, wherein the natural computing algorithm comprises a genetic algorithm (GA).

12. The method of claim 11, further comprising executing the genetic algorithm (GA) by:
selecting a set of test cases from the selected population of test cases, wherein the selected set of test cases comprises test cases having a highest fitness score;
generating, based at least in part on the selected set of test cases, at least one new test case by 1) identifying a crossover point between at least one pair of test cases of the selected set of test cases and 2) alternating one or more values of a sequence of values representative of each test case of the at least one pair of test cases, the one or more values of the sequence of values being alternated until the identified crossover point between the at least one pair of test cases is reached;
performing a mutation of the at least one new test case by altering one or more values of a sequence of values representative of the at least one new test case; and
generating a new population of test cases, wherein the new population of test cases comprises the at least one new test case.

13. The method of claim 8, wherein determining whether the identified one or more best possible test cases satisfies the second set of fitness criteria further comprises determining whether the identified one or more best possible test cases satisfies one or more of a credibility criterion, a feasibility criterion, a requirements coverage criterion, or a requirements traceability criterion.

14. The method of claim 8, further comprising:
prior to accessing the selected population of test cases and the first set of fitness criteria, generating the selected population of test cases based on the total population of test cases.

15. A non-transitory computer-readable medium storing instructions that, when executed by one or more processors of a system, cause the one or more processors to:
access a selected population of test cases, a first set of fitness criteria, and a second set of fitness criteria, wherein the selected population of test cases is configured to test a functionality of one or more of a first instance of a software application or a second instance of the software application, and wherein the selected population of test cases comprises a subset of a total population of test cases;
determine, based on the selected population of test cases and the first set of fitness criteria, a fitness score for each test case of the selected population of test cases;
iteratively execute a natural computing algorithm to identify one or more best possible test cases based at least in part on the fitness score for each test case of the selected population of test cases;
in response to determining that the identified one or more best possible test cases satisfies the second set of fitness criteria, generate an output comprising the identified one or more best possible test cases; and
execute, based at least in part on the output, the identified one or more best possible test cases to test the functionality of the one or more of the first instance of the software application or the second instance of the software application.

16. The non-transitory computer-readable medium of claim 15, wherein the first instance of the software application comprises an instance of the software application during development time, and wherein the second instance of the software application comprises an instance of the software application during runtime.

17. The non-transitory computer-readable medium of claim 15, wherein the instructions further cause the one or more processors to:
prior to determining the fitness score for each test case of the selected population of test cases:
initialize the selected population of test cases; and
assign each test case of the selected population of test cases to one of a plurality of test suites based at least in part on a functionality to be tested.

18. The non-transitory computer-readable medium of claim 15, wherein the natural computing algorithm comprises a genetic algorithm (GA).

19. The non-transitory computer-readable medium of claim 18, wherein the instructions further cause the one or more processors to execute the genetic algorithm (GA) by:
selecting a set of test cases from the selected population of test cases, wherein the selected set of test cases comprises test cases having a highest fitness score;
generating, based at least in part on the selected set of test cases, at least one new test case by 1) identifying a crossover point between at least one pair of test cases of the selected set of test cases and 2) alternating one or more values of a sequence of values representative of each test case of the at least one pair of test cases, the one or more values of the sequence of values being alternated until the identified crossover point between the at least one pair of test cases is reached;
performing a mutation of the at least one new test case by altering one or more values of a sequence of values representative of the at least one new test case; and
generating a new population of test cases, wherein the new population of test cases comprises the at least one new test case.

20. The non-transitory computer-readable medium of claim 15, wherein the instructions further cause the one or more processors to determine whether the identified one or more best possible test cases satisfies the second set of fitness criteria based at least in part on whether the identified one or more best possible test cases satisfies one or more of a credibility criterion, a feasibility criterion, a requirements coverage criterion, or a requirements traceability criterion.
